(19) United States
(12) Patent Application Publication
(10) Pub. No.: US 2006/0088140 A1
(43) Pub. Date: Apr. 27, 2006

(54) System and method for performing scatter measurement in volumetric CT

(76) Inventors: Rebecca Fahrig, Palo Alto, CA (US); Norbert Karl Strobel, Palo Alto, CA (US); Lei Zhu, Stanford, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/240,233

(22) Filed: Sep. 30, 2005

Related U.S. Application Data
(60) Provisional application No. 60/614,581, filed on Sep. 30, 2004.

(51) Int. Cl. G21K 1/00

(52) U.S. Cl. 378/154

(57) ABSTRACT

The invention provides a system and method for reducing the affects of scattering in an image. The system and method comprises providing at least one blocker array between an x-ray source and an object, obtaining a first image of the via a detector and a first signal, rotationally displacing the at least one blocker array, wherein primary radiation is disrupted at different locations in each projection image, obtaining a second image of the object via the detector and a second signal, estimating the scatter based on a comparison of the first signal and the second signal, and reconstructing a final image by accounting for scatter.

### CLAIM OF PRIORITY

This application claims the benefit under 35 U.S.C. §120 from U.S. Provisional patent application Ser. No. 10/614,581 titled “A METHOD FOR SCATTER MEASUREMENT IN VOLUMETRIC CT” filed on Sep. 30, 2004, the entire contents of which is incorporated herein by reference.

### STATEMENT OF GOVERNMENT INTEREST

The present invention was developed with the support of NIH Grant No. R01EB0003524-01.

### BACKGROUND OF THE INVENTION

1. Field of the Invention

The present invention relates to a system and method for reducing x-ray scatter in imaging systems. More particularly, the present invention relates to x-ray scatter reduction using a single scan in cone beam computed tomography (CBCT).

2. Description of the Related Art

X-ray scattering deteriorates the image quality and accuracy of x-ray imaging equipment. Cone beam computed tomography (CBCT) is much more sensitive to scatter than fan beam CT. Scatter corrupts image projection data and causes a phenomena known as cupping. Developing an effective scatter correction method is one of the major challenges in the CBCT research field. A conventional scatter correction method comprises direct measurement of the scatter field. This method typically provides the most accurate field estimate. For example, the standard approach to scatter measurement uses an array of lead blockers placed between the x-ray source and the object to be x-rayed. When the area of the blockers is small, the system is not significantly affected by scatter compared to the case without the blocker array, and the projection data in the shadows of the blockers on the detector can be regarded as samples of the scatter profile. Due to the low-frequency behavior of the scatter, an improved estimate of the full scatter field can then be obtained by performing low-pass filtering. However, since the array blocks primary projections as well, a complete and accurate reconstruction of the primary profile is impossible to obtain.

Conventionally, scanning with the blocker array is typically used to obtain the scatter estimation only, as a pre-calibration prior to the conventional scanning without the blocker array. U.S. Pat. No. 6,618,466 issued to Ruola Ning (hereinafter “Ning”), which is incorporated by reference in its entirety, illustrates disadvantages with the prior art. Ning discloses using lead blockers to measure scatter for volume CT scanners. However, Ning discloses placing a grid of blockers in front of the x-ray source and capturing the image, and then removing the grid of blockers and capturing the image without the grid of blockers. It should be noted that the images must be taken in exactly the same position as when the grid of blockers were in place.

There are a number of problems with the Ning approach. First, additional x-ray dose is given to the patient, which may be harmful to the patient over time. Second, disruption of the clinical work-flow occurs because you have an additional step of adding and removing the grid of blockers. This may also lead to errors where a technician inadvertently fails to remove or add the grid of blockers. Third, potential motion of the patient between characterization of the scatter fields and the volume CT acquisitions may occur resulting in an erroneous reading. Fourth, there is a complete loss of data occurs behind the grid of blockers.

Thus, there is a need for a system and method where quality reconstructed images can be obtained with the grid of blockers in place.

### SUMMARY OF THE INVENTION

It is therefore an object of the present invention to provide a system and method where quality reconstructed images can be obtained with the grid of blockers in place.

It is a further an object of the present invention to reduce x-ray scatter interference.

It is another object of the present invention to reduce radiation exposure to an object by reducing the number of images required to be taken.

It is an additional object of the present invention to obtain measurements of the x-ray scatter field during a single computed tomography

According to an aspect of the invention for realizing the above objects, there is provided a system and method for reducing x-ray scatter comprising providing at least one blocker array between an x-ray source and an object, obtaining a first image of the via a detector and a first signal, rotationally displacing the at least one blocker array, wherein primary radiation is disrupted at different locations in each projection image, obtaining a second image of the object via the detector and a second signal, estimating the scatter based on a comparison of the first signal and the second signal, and reconstructing a final image by accounting for scatter.

### BRIEF DESCRIPTION OF THE DRAWINGS

Exemplary embodiments of the present invention will be set forth in detail with reference to the drawings, in which like reference numerals refer to like elements:

FIG. 1 is a diagram illustrating a Cone beam computed tomography (CBCT) system having a moving blocker array in accordance with an embodiment of the present invention;

FIGS. 2A-2D comprise computer generated images taken in accordance with an embodiment of the present invention;

FIG. 3 is a diagram illustrating relative reconstruction error (RRE) in accordance with an embodiment of the present invention;

FIG. 4 is a diagram illustrating standard deviation of square error (SDSE) in accordance with an embodiment of the present invention;

FIGS. 5A-5E are images illustrating the influence of scatter on an object in accordance with an embodiment of the present invention;

FIGS. 6A-6D are images illustrating various interpolation methods in accordance with an embodiment of the present invention; and

FIGS. 7A-7D are images illustrating reconstruction of primary interpolation error using various interpolation methods.

### DETAILED DESCRIPTION OF EXEMPLARY EMBODIMENTS

Several exemplary embodiments of the present invention will now be described in detail with reference to the accompanying drawings. In the drawings, the same or similar elements are denoted by the same reference numerals even though they are depicted in different drawings. In the following description, a detailed description of known functions and configurations incorporated herein has been omitted for conciseness.

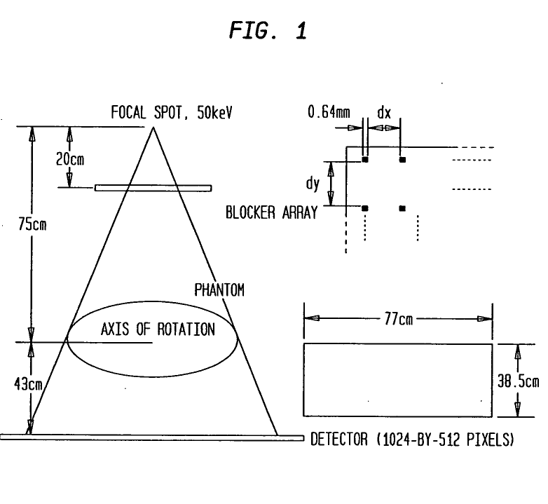

FIG. 1 is a diagram illustrating a cone beam computed tomography (CBCT) system 10 having a moving blocker array in accordance with an embodiment of the present invention. Specifically, the configuration of the CBCT system 10 comprises an x-ray source 12, a blocker array 14, an object or phantom 16, a detector 18 and a processor (not shown) for processing results and/or controlling the operation of the CBCT system 10. The blocker array 14 is disposed between the x-ray source 12 and the phantom 16. The x-ray source provides an exemplary focal spot of 50 Kev. The phantom 16 is disposed on an apparatus having a rotational axis. However, it should be appreciated by those skilled in the art that the apparatus having a rotational axis can be eliminated if the x-ray source can be displaced in a rotational or linear direction.

The motion or displacement of blockers 14 can be arbitrary motion as long as the location of the blockers 14 can be determined. The motion of the blocker array 14 should be preferably such that the positions of the blocker arrays 14 do not overlap significantly from one projection image to the next. Preferably, there is no overlap between the images. It can also be contemplated that the x-ray source 12, detector 18 and apparatus having a rotational axis or displacement can be utilized in combination or separately without departing from the scope of the present invention.

Measurement of x-ray scatter during a single CT acquisition is obtained for example, during rotation of the x-ray source 12 and detector 18 around a patient or phantom 16 or during rotation of the patient or phantom 16 during the acquisition of images. This provides correction of the recorded data prior to reconstruction. Estimates of the scatter field is obtained by placing a grid of blockers or blocker array 14 in front of the x-ray source 12 such that the x-ray intensity is either reduced or completely blocked by the blocker array 14, and primary radiation does not hit the object or phantom 16 or is reduced in intensity where the blocker array 14 is located. The signal measured behind the blocker array 14 can then be used to obtain an estimate of the scatter field. The estimate of the scatter field is subtracted from the measured data before reconstruction is performed. Therefore, the inaccuracies in the CT are reduced.

In accordance with an embodiment of the present invention, the blocker array is moved between each image capture e.g., between each image angle, so that the primary radiation is disrupted at different locations in each projection image.

In accordance with embodiments of the present invention, the grid array 14 can comprise any type of blocking material providing full blocking such as lead or partial blocking such as aluminum. The blocker array 14 can comprise any shape, size or thickness and may be of a solid form or include perforations. It should be noted that the accuracy of the estimate of the scatter field will be affected by these parameters.

Referring to FIG. 1, exemplary system parameters used in computer simulations are also provided in FIG. 1. The size of blocker array 14 is chosen to ideally minimize the perturbation or disturbance of the primary field for which small blockers are preferred as well as the penumbra edge effects for which large blockers are preferred, and only the data acquired at the center of the shadows are used as the samples of the scatter profile.

The shadows of the blockers on the detector are 5 pixels in diameter, dx pixels apart in the x direction, and dy pixels apart in the y direction. dx and dy are optimized using simulation experiments. In every projection, the scatter correction comprises three steps: 1) estimate the full scatter field based on the sample data in the blocker shadows using proper upsampling techniques involving low-pass filtering; 2) subtract the scatter estimate from the initial projection to obtain a primary estimate in the regions outside the blocker shadows; 3) estimate the primary data in the blocker shadows by interpolating the primary estimate obtained in step 2).

The error distribution of projection data after scatter correction is performed is not uniform on the detector 18. It is dependent on the position of the blocker shadows. Small errors tend to occur around the blocker shadows, while large errors are more likely in the middle between two blocker shadows, due to the scatter estimation error that resulted in step 1, and inside the shadows, largely due to the primary estimation performed in step 3. Therefore, if a stationary blocker array is used, every projection will have a similar error distribution. Hence, more artifacts will appear in the reconstructed image. Moving the blocker array 14 is a straightforward solution to this problem. The blocker array 14 moves at least one blocker diameter from projection to projection, so that each detector pixel will not be consecutively blocked during the rotational data acquisition.

Although more sophisticated moving trajectories can be designed for computer simulations, an exemplary raster-moving trajectory was chosen for its ease of operation and low mechanical error in implementation. The artifact reduction is very impressive. For simplicity, hereafter, we refer to the term blocker array trajectory as the trajectory of the array shadow on the detector, and use the term pixel as the unit of movement.

The scatter estimation performed in step 1) mainly determines the performance of an algorithm, since its error will propagate into step 3) and increase the primary estimation error. How to choose the sampling period of the scatter data, i.e., the blocker distances dx and dy, is an important consideration in this algorithm. The choice of dx and dy is a trade-off among many issues. For example, if the blocker distance is too large, the scatter estimation is inaccurate due to aliasing. If the blocker distance is too small, then inaccuracy arises due to four effects. First, the blocker array disturbs the system such that the scatter profile has high-frequency components, undermining the basic assumption of this algorithm and making scatter estimation inaccurate. Second, the system will have more loss of radiation due to more primary blocking, and more x-ray tube power is needed to keep the same exposure. Third, error will arise in step 3), because more of the primary signal must be estimated as the blocker shadow area increases. Finally, since the blocker array moves at least one blocker diameter per projection, it will go back to the same position after a certain number of projections. If the blocker distance is small, this repetition period is short, and the artifact reduction performance using a moving trajectory will be degraded. The complexity makes it difficult to find the optimal blocker distance analytically. Therefore, simulation experiments are used to optimize the blocker distance.

Subtraction of scatter estimate from the total projection in step 2) is also important. The projection data used in reconstruction is calculated using log(I₀/Pₑₛₜ), where I₀ is the photon density of the x-ray source, and Pₑₛₜ is the primary estimate. If the true primary is small, the primary estimate error will be magnified. This error is the same as the scatter estimation error in step 1), and its distribution is almost independent of the primary profile. Therefore, large errors in reconstruction always occur in the directions of high scatter-to-primary ratios (SPRs).

This problem is generally true in the framework of scatter estimation using measurement samples, and a complete solution to this problem is not simple due to its nonlinearity. However, the error can be constrained from being arbitrarily high using a simple technique.

In the algorithm used in accordance with an embodiment of the present invention, if the primary estimate is less than a threshold, which is a very small positive value, it is set to that value using a hard cutoff. A large reconstruction error is greatly suppressed in this way, while artifacts are still noticeable.

The final reconstruction is also sensitive to the interpolation method used in the primary estimation in step 3). Since some primary data are missing in the 2D profile, it is tempting to fill in the data using a conventional 2D interpolation method. As is generally true in interpolation, a shift-invariant weight distribution is used to characterize the contribution of the adjacent data to the missing value. In the case of a cone beam, back projection (BP) based reconstruction algorithms typically process every horizontal line separately, as a fan-beam projection, and the weight distribution in the correct interpolation is shift-invariant in the horizontal direction. In the vertical direction, however, the weight distribution is shift-variant. A detailed discussion regarding the optimal 2D interpolation method is beyond the scope of this invention. 1D cubic spline interpolation (in the horizontal direction) to estimate the primary is used, and the comparison of reconstructions using 2D and 1D interpolations is provided below.

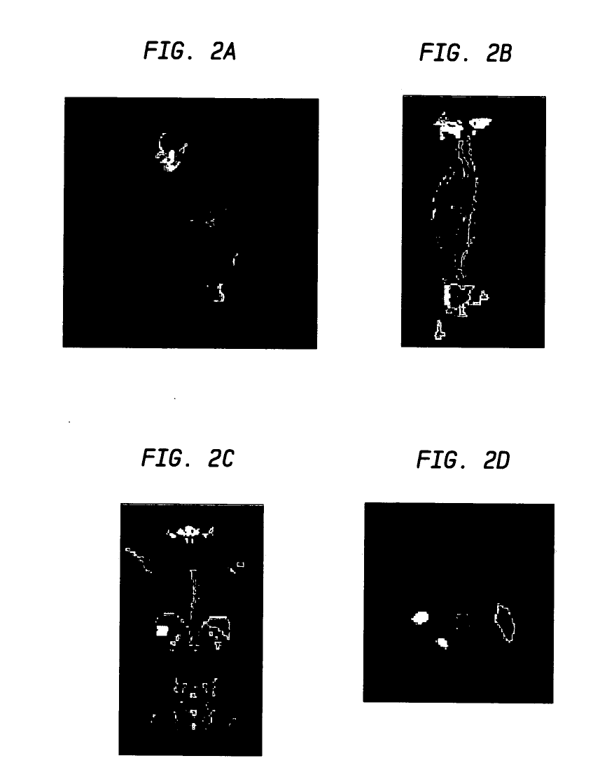

FIGS. 2A-2D comprise computer generated images taken in accordance with an embodiment of the present invention. The system performance was first tested using an exemplary Monte Carlo (MC) simulation (Geant4) on an exemplary Zubal phantom 16, shown in FIG. 2. The phantom 16 comprises a humanoid software phantom from head to hip, with an exemplary total size comprising 128-x-128-x-243 and 4 mm resolution. A chest scan was performed for algorithm evaluation purposes, since there is large variation in scatter and primary in the z-direction. The scan comprises full-angle, circular, 360 projections, and the mid-plane is on the slice 108 of the phantom. The reconstructed volume comprises 512-x-512-x-64, with 0.78125 mm resolution in all directions. Since generating scatter profiles using MC simulation is very time consuming, an exemplary Richardson-Lucy (RI) fitting algorithm is used such that accurate and noiseless scatter profiles can be obtained using a much smaller number of photons. It should be appreciated by those skilled in the art that any suitable algorithm can be used without departing from the scope of the present invention. The acceleration of the MC simulation using this algorithm stems from the fact that scatter profiles are always very smooth (low-frequency), so the high-frequency statistical noise in the simulation of relatively few photons can be removed after curve fitting. The primary projections are calculated separately using line integration and weighted to match the SPR. Denoting S and P as the scatter and primary profiles obtained from MC simulation, S_{RL} as the scatter profile after RL fitting, and P_{LI} as the primary profile by line integral calculation, then the weight factor K on P_{LI} for each projection is computed as follows for equation 1:

$$\frac{K \cdot \sum {P}_{LI} ( i , j )}{\sum {S}_{RL} ( i , j )} = \frac{\sum P ( i , j )}{\sum S ( i , j )} ⇒ K = \frac{\sum {S}_{RL} ( i , j )}{\sum {P}_{LI} ( i , j )} \cdot \frac{\sum P ( i , j )}{\sum S ( i , j )} \qquad ( 1 )$$

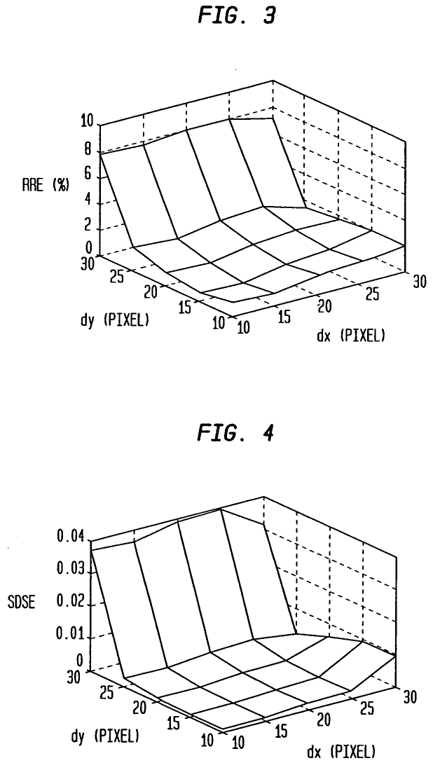

FIG. 3 is a diagram illustrating relative reconstruction error (RRE) in accordance with an embodiment of the present invention. FIG. 4 is a diagram illustrating standard deviation of square error (SDSE) in accordance with an embodiment of the present invention.

The reconstruction results after scatter correction, T(x,y,z), are compared to the reconstruction using primary projections only, T₀(x,y,z), such that the relative error is only due to the scatter correction algorithm rather than the cone beam reconstruction. The mean square error inside the reconstructed volume has been used to characterize the reconstruction accuracy. The relative reconstruction error (RRE) is defined using equation 2 as:

$$RRE = 100 \cdot \sqrt{mean [ {( \frac{T ( x , y , z ) - {T}_{0} ( x , y , z )}{{T}_{0} ( x , y , z )} )}^{2} ]} \qquad ( 2 )$$

where x and y are only those inside the reconstructed body. T and T₀ are in Hounsfield unit (HU), but shifted by 1000, such that air is 0 HU and water is 1000 HU. In this manner, the reconstruction is linear, i.e. the difference between two reconstructed images is the same as the reconstruction using the projection difference.

The artifacts in the reconstructed image are due to the local concentration of the error. To quantify the artifact level, the standard deviation of square error (SDSE) is also defined using equation 3 as:

$$SDSE = \sqrt{var [ {( \frac{T ( x , y , z ) - {T}_{0} ( x , y , z )}{{T}_{0} ( x , y , z )} )}^{2} ]} \qquad ( 3 )$$

A frequency spectrum analysis of scatter profile provides dx=˜25 and dy=˜30 as a rough estimate of the optimal blocker distance. For the sake of reducing simulation time, we assume the system is not disturbed significantly even if small blocker distances are used, and use the same scatter profile for all the simulations. FIGS. 3 and 4 show RRE and SDSE of simulations using different blocker distances around that estimate. The minimum RRE 0.62% occurs at dx=15 and dy=15.

These figures illustrate an analysis of optimizing the blocker distance. As the blocker distance decreases from a large number, the RRE and SDSE decrease in the first instance, since a finer sampling provides a better scatter estimation. However, artifact reduction obtained by motion of the blockers decreases at the same time. If the blocker distance is too small, the artifacts can not be removed effectively and the residue causes RRE and SDSE to increase. Taking into consideration that small blocker distance also has more loss of radiation and disturbance of the system, a reasonable and conservative choice of blocker distance is dx=20 and dy=15; in this case, RRE=1.13% and SDSE=8.10e-4, only 8.3% of the primary radiation is disrupted, and the blocker perturbation or disturbance of the scatter distribution is small.

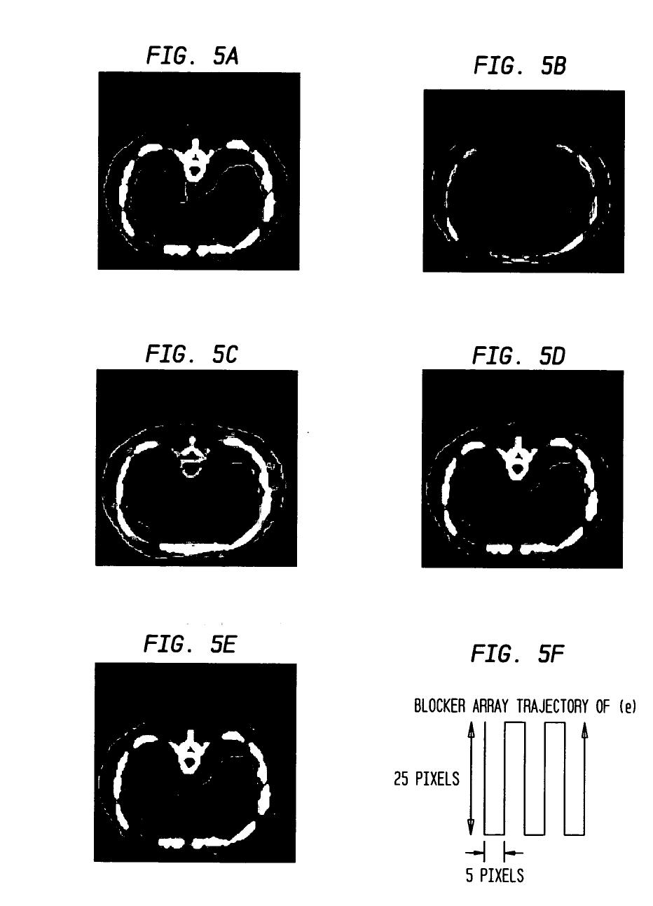

FIGS. 5A-5E are images illustrating the influence of scatter on an object in accordance with an embodiment of the present invention. Specifically, The reconstructed image using the optimized blocker distance is shown in FIG. 5E As a reference, FIG. 5A comprises the image reconstructed using primary projections only, i.e., the scatter correction is perfect; and the worst case is shown in FIG. 5B, where no scatter correction is applied and the image is reconstructed using primary plus scatter projections.

The result that is obtained if the boundary of the object is known, and it is assumed that the object is composed of water only (i.e., uniform water correction) is also shown. The cupping/shading distortion in FIG. 5C is still very severe, which indicates that the scatter is very sensitive to the composition of the object, and this estimation method is unlikely to achieve an accurate reconstruction in objects with high heterogeneity.

FIG. 5D is the reconstructed image with optimized blocker distance while the blocker array is held stationary during projection acquisition. Noticeable ring artifacts are present in the image, although missing projection data at the blocker shadows has been interpolated relying on an exemplary 1D cubic spline technique. These artifacts are reduced in FIG. 5F, when the blocker array was moved along a raster-scanning trajectory in addition to the same shadow interpolation approach.

The RRE, SDSE and SDSE/RRE values for the images in FIG. 5 are summarized in Table. 1. The RRE is reduced from 32.3% with no scatter correction to 1.13% with scatter corrected by moving blockers 14. The SDSE is also largely reduced in the same manner from 0.339 to 8.10e-4. The low SDSE/RRE value implies that the error is smoothly distributed and the cupping distortion is greatly removed. It should be noted that although the RRE decreases due to motion of the blocker array 14 is very small, the SDSE drops by −10%. This, again, reveals that the residual artifact is removed, as shown in FIGS. 5D and 5E.

TABLE 1

| | b) | c) | d) | e) |
|---|---|---|---|---|
| RRE | 32.3% | 20.1% | 1.17% | 1.13% |
| SDSE | 0.339 | 0.197 | 9.14e−4 | 8.10e−4 |
| SDSE/RRE | 1.05 | 0.979 | 0.0782 | 0.0714 |

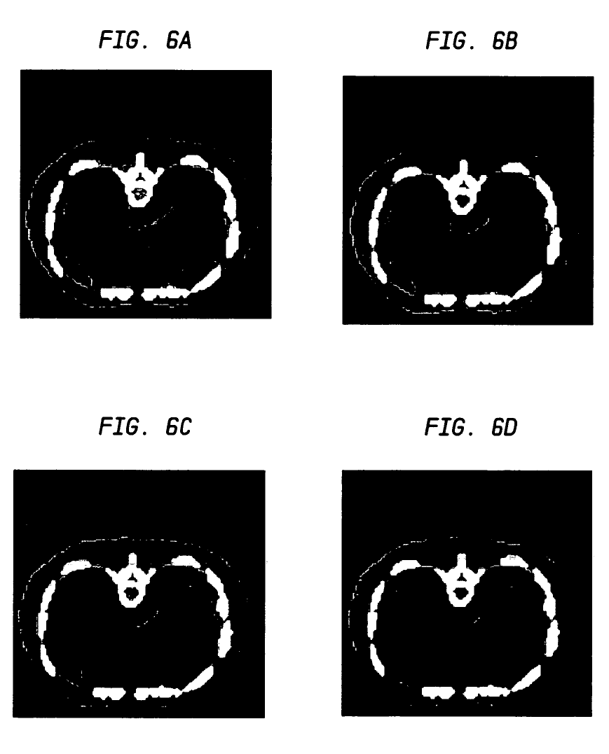

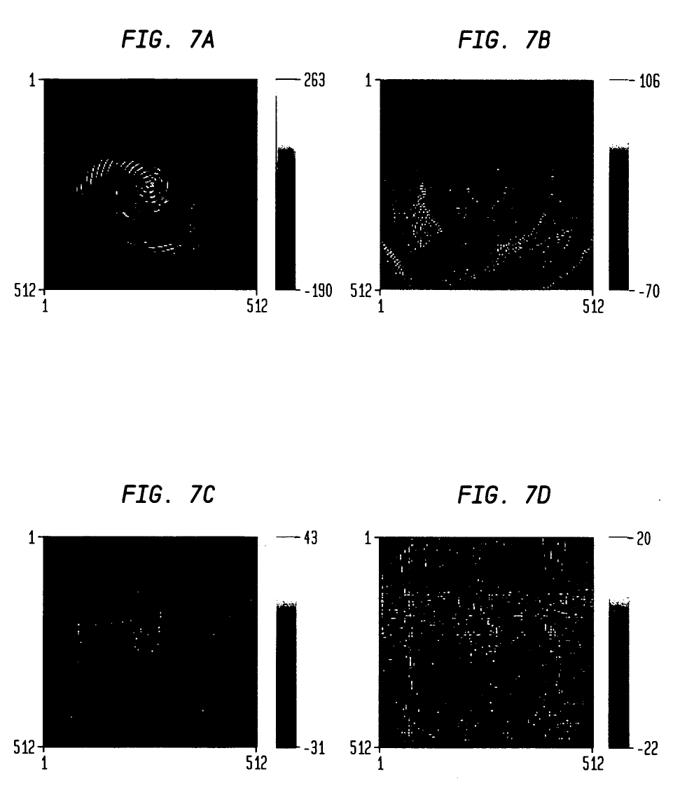

Further analysis discloses the effect of different primary interpolation methods on the image quality. The primary interpolation is more inaccurate if the missing data have high frequency components. So the artifacts due to interpolation error are more prominent in the slice where a large primary variation occurs. In the reconstructed volume, slice 35 is cutting the edge of the heart, and it is chosen to illustrate the problem in FIGS. 6 and 7.

FIGS. 6A-6D are images illustrating various interpolation methods in accordance with an embodiment of the present invention. Specifically, FIG. 6 compares the reconstruction results of 2D and 1D primary interpolation methods. FIG. 6A uses 2D primary interpolation and stationary blocker array trajectory, and the ring artifacts in the image are very severe. This is because the interpolation error stays at the same location for all projections acquired during a scan. This setup resembles the case when the detector has ‘bad’ pixel elements. By moving the blocker array 14, the ‘bad’ pixel elements move from projection to projection and, as a result, streak artifacts appear in the reconstructed image, as shown in FIG. 6B. By contrast, these artifacts are invisible in the reconstruction using 1D primary interpolation. These errors are more clearly illustrated if focus is placed on reconstruction error due to primary interpolation only. Since the cone beam reconstruction is linear, this error can be computed from the reconstruction using primary interpolation error.

FIGS. 7A-7D are images illustrating reconstruction of primary interpolation error using various interpolation methods in accordance with an embodiment of the present invention. Specifically, FIG. 7 shows selected slices of the error volumes depicting the artifacts due to primary interpolation. The comparison reveals that the 1D interpolation method has much smaller error, and raster motion of the blocker array also reduces the error further. While the artifacts of 2D primary interpolation can also be easily found in FIG. 6, those of 1D interpolation are masked by scatter estimation artifacts and are difficult to see. From that, it can be reasoned that the majority of residual artifact is due to scatter estimation if 1D primary interpolation is applied.

Direct measurement of scatter samples using a moving blocker array 14 has been disclosed. The scatter correction algorithm is designed and tested on a software phantom 16. It has been shown that this scatter correction method can substantially reduce the image distortion caused by scatter. By optimizing the blocker distance, only −8% of the primary projection is blocked, and the relative reconstruction error is −1%, as compared to −30% without scatter correction.

Although considerable improvement in image quality can already be obtained by using a stationary blocker array combined with 1D interpolation, both the SDSE analysis and a visual inspection reveal that a raster-motion of the blockers results in fewer noticeable structural artifacts. If 1D primary interpolation is applied, then the residual artifact arises mostly due to inaccurate scatter estimates, rather than due to interpolation of the primary data.

Further reduction of the residual error requires refinement of the scatter correction algorithm. The algorithm disclosed in accordance with an embodiment of the present invention estimates the scatter distribution on scatter samples only. However, the reconstruction error depends on not only the scatter estimation error, but the primary value at that position as well.

An improved algorithm could use the scatter plus primary profile as a condition to constrain the error distribution in the scatter estimation. The primary interpolation method also must be further optimized. Although 1D primary interpolation is shown to outperform 2D interpolation, it is still not the optimal.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of providing an image while correcting for scatter, the method comprising:
providing at least one blocker array between an x-ray source and an object;
obtaining a first image of the via a detector and a first signal;
rotationally displacing the at least one blocker array, wherein primary radiation is disrupted at different locations in each projection image;
obtaining a second image of the object via the detector and a second signal;
estimating the scatter based on a comparison of the first signal and the second signal; and
reconstructing a final image by accounting for scatter.

2. The method according to claim 1, wherein the at least one blocker array comprises lead.

3. The method according to claim 1, wherein the at least one blocker array comprises aluminum.

4. The method according to claim 1, wherein the at least one blocker array comprises a fully blocking.

5. The method according to claim 1, wherein the at least one blocker array comprises a non-fully blocking material.

6. The method according to claim 1, wherein the at least one blocker array comprises perforations.

7. The method according to claim 1, wherein the at least one blocker array comprises a non perforated surface.

8. The method according to claim 1, further comprising rotating the x-ray source and detector around the object and blocker array.

9. The method according to claim 1, further comprising rotating the object.

10. The method according to claim 1, wherein the detector comprises a large surface area.

11. The method according to claim 1, further comprising rotating the x-ray source and detector around the object and blocker array.

12. The method according to claim 1, wherein the x-ray source provides a cone beam.

13. The method according to claim 1, further comprising:
obtaining the measurements in a single scan.

14. The method according to claim 1, further comprising:
moving the at least one blocker array, wherein every detector pixel is not consecutively blocked during data acquisition.

15. The method according to claim 14, further comprising:
estimating missing primary data in blocker shadows via interpolation.

16. A system for providing an image while correcting for scatter, comprising:
An x-ray source for providing a cone beam;
at least one blocker array disposed between x-ray source and an object;
a detector for obtaining a first image of the via a detector and a first signal and obtaining a second image of the object via the detector and a second signal;
a controller for rotationally displacing the at least one blocker array, wherein primary radiation is disrupted at different locations in each projection image, estimating the scatter based on a comparison of the first signal and the second signal, and reconstructing a final image by accounting for scatter.

17. The system of claim 16, wherein the controller moves the at least one blocker array, wherein every detector pixel is not consecutively blocked during data acquisition.

18. The system of claim 17, wherein the controller estimates missing primary data in blocker shadows via interpolation.

19. The system of claim 16, wherein the controller obtains the measurements in a single scan.

20. The system of claim 16, wherein the system comprises a cone beam computed tomography.
